(19) United States
(12) Patent Application Publication
(10) Pub. No.: US 2015/0076078 A1
(43) Pub. Date: Mar. 19, 2015

(54) CHEMICAL PROCESS TO REMOVE SUSPENDED SOLIDS

(71) Applicant: ICM, Inc., Colwich, KS (US)

(72) Inventor: Charles C Gallop, Gower, MO (US)

(21) Appl. No.: 14/486,970

(22) Filed: Sep. 15, 2014

Related U.S. Application Data
(60) Provisional application No. 61/878,680, filed on Sep. 17, 2013.

(51) Int. Cl. B01D 37/03; B01D 21/00; B01D 21/01; B01D 33/06

(52) U.S. Cl. CPC B01D 37/03; B01D 33/06; B01D 21/0012; B01D 21/01
USPC 210/724; 210/723

(57) ABSTRACT

This disclosure describes providing techniques to remove suspended solids from a process stream. This disclosure describes a method for adding a chemical, a cationic flocculant to the process stream, in which the chemical induces flocs of suspended solids. The process removes the flocs of suspended solids by using a device. This creates two streams, a liquids and dissolved solids stream and a suspended solids stream.

### CROSS-REFERENCE TO RELATED APPLICATION

This application claims the benefit of priority to U.S. Provisional Application No. 61/878,680, entitled “Chemical Process to Remove Suspended Solids,” filed on Sep. 17, 2013, the content of which is hereby incorporated by reference in its entirety.

### TECHNICAL FIELD

The subject matter of this disclosure relates to methods of removing suspended solids from process streams in a production facility. In particular, the subject matter is directed to adding a chemical to a process stream that is used in combination with a mechanical device to enhance solid-liquid separation, to remove suspended solids, to recover components, to reduce energy needed for processing process stream downstream, and to increase overall efficiency of a process.

### BACKGROUND

There are known techniques to separate solids from liquids in process streams. For instance, one method uses heat and a centrifuge with the process streams to separate and to recover various components. Problems are that the centrifuge does not adequately separate components in the process streams, is expensive to purchase and to operate, and requires frequent maintenance and repair. Other types of equipment have been attempted for solids-liquids separation, but tend to drive up capital costs.

In an example, of a dry milling process for producing biofuel, the centrifuge may be used to separate solids, (referred to as wet cake), from liquids, (referred to as centrate). The wet cake is sent to dryers to dry to about 10 to 12% moisture or less, which is referred to as Dried Distillers Grain (DDG). The centrate may contain about 6 to 8% solids by weight, about 3 to 4% suspended solids, and about 3 to 4% dissolved solids. Typically, a process sends a portion of the centrate, which is known as backset, back to a front end of the process to be combined with water and feedstock. In some cases, backset may be sent from after distillation. However, a problem occurs when sending the backset, which tends to contain solids, sugar, acid, glycerol, furfural, minerals, ions, and the like. Due to the amount of solids, the amount of energy required to transport backset and to remove backset from the process increases. Thus, there is an increase in operating costs. Also, too much backset may create problems with fermentation due to an overabundance of minerals and ions suppressing fermentation.

Another portion of the centrate, thin stillage, may be sent to the evaporators for concentrating into syrup, which then becomes blended with wet cake to produce animal feed, Dried Distillers Grain with Solubles (DDGS). However, the centrate could contain high amounts of suspended solids. Thus, the centrate with the high amounts of suspended solids may cause efficiency problems in the evaporators. Furthermore, this processing step of evaporating to concentrate solids in high water content streams requires a significant amount of energy. Thus, the amount of energy required increases the operating costs.

Accordingly, there is a need for improved methods for removing solids from process streams in a more efficient manner without increasing the amount of energy, operating costs, or capital costs.

### SUMMARY

This disclosure describes reducing an amount of energy used for downstream processing, reducing operating costs, and reducing capital costs to remove suspended solids from process streams; to recovering components; to enhancing solid-liquid separation; and to improving overall efficiency in a production facility. For instance, the production facility may include, but is not limited to, biofuels, alcohol, animal feed, pulp and paper, oil, biodiesel, and the like.

In an embodiment, a process adds an effective amount of a cationic flocculant to a process stream. The process agitates the cationic flocculant in the process stream for a predetermined amount of time in a tank to induce flocculation of two or more particles to aggregate and to form flocs of suspended particles. Next, the process removes the flocs of suspended particles from dissolved particles in the process stream with the cationic flocculant. The process produces a suspended particles stream and a clarified process stream.

In another embodiment, a process adjusts pH of a process stream and adds an effective amount of a charged polymer to the process stream. The charged polymer causessuspended solids to aggregate and to form flocs. The process separates the flocs of suspended solids from the process stream with the charged polymer to create a suspended solids stream and a liquid with dissolved solids stream.

In yet another embodiment, a process adds an effective amount of a chemical for producing flocculation in a process stream. The process agitates the chemical in the process stream in a tank to induce flocculation of suspended solids and separates the flocculation of suspended solids from the process stream with the chemical.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other aspects and advantages of the claimed subject matter will be apparent from the following Detailed Description of the embodiments and the accompanying figures.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. The features illustrated in the figures are not necessarily drawn to scale, and features of one embodiment may be employed with other embodiments as the skilled artisan would recognize, even if not explicitly stated herein.

FIG. 1 illustrates an example environment for removing suspended solids from a front-end process stream in a production facility.

FIG. 2 illustrates an example of a chemical process that may be used in FIG. 1.

FIG. 3 illustrates another example of a chemical process combined with a device that may be used in FIG. 1.

FIG. 4 illustrates another example environment for removing suspended solids from a back-end process stream in a production facility.

FIG. 5 illustrates an example of a chemical process with a treatment process that may be used in FIG. 4.

FIG. 6 illustrates another example of a chemical process with a treatment process that may be used in FIG. 4.

### DETAILED DESCRIPTION

### Overview

The Detailed Description explains embodiments of the subject matter and the various features and advantageous details more fully with reference to non-limiting embodiments and examples that are described and/or illustrated in the following attached description and accompanying figures. Descriptions of well-known components and processing techniques may be omitted so as to not unnecessarily obscure the embodiments of the subject matter. The examples used herein are intended merely to facilitate an understanding of ways in which the subject matter may be practiced and to further enable those of skill in the art to practice the embodiments of the subject matter. Accordingly, the examples, the embodiments, and the figures herein should not be construed as limiting the scope of the subject matter.

This disclosure describes environments and techniques for removing suspended solids from a process stream obtained from the production facility. Removal of the suspended solids from the process stream will reduce a number of total solids in downstream process streams, reduce amounts of energy needed in downstream process streams, reduce viscosity of these streams, enhance more efficient solid-liquid separation, and allow more efficient dewatering or separation. Furthermore, the process may concentrate soluble solids more easily since the suspended solids are removed from the process stream. Thus, the process reduces energy usage downstream and operating costs while improving effiency in the production facility.

A dry grind process may have trouble converting starch to ethanol. A common problem occurs when the solids content is elevated during a conversion of starch to dextrins and sugars. The elevated solids content tends to negatively increase viscosity of the slurry and to decrease yield from a fermentation process. The increase in viscosity also negatively affects the movement of the slurry in the process while the decrease in yield from fermentation is attributed to the difficulty in hydrolyzing starch to dextrins. Also, an increase in suspended solids content causes a decrease in the amount of water available in the process. However, water is required for hydrolysis of starch to dextrins. Thus, the decrease in water decreases a rate of hydrolysis and the ability to get a completion of the hydrolysis.

Accordingly, this disclosure describes environments and techniques to address removing suspended solids from process streams to enhance solid-liquid separation, to recover solids, germ, fiber, oils, proteins, and to increase overall efficiency of the production facility. For instance, the techniques describe a chemical process that creates flocculation of suspended solids in process streams and removes the suspended solids in an improved separation process, which efficiently dewaters the process streams.

In an embodiment, a chemical process adds a chemical to a process stream. The chemical induces flocculation by causing suspended particles or solids to aggregate and form flocs. The process uses an agitator in a tank to further mix the chemical with the process stream to cause the suspended particles or solids to come together or to collide, allowing large-size clusters to form. Next, the process uses a device to separate the suspended particles or solids from dissolved solids in liquid. In some instances, the process produces dissolved solids in liquid (i.e., clarified sugar stream) and suspended particles or solids to be further processed.

In another embodiment, similar to the one above, but using a different process stream obtained from another area in the production facility, a process adds a treatment process. The process performs similar steps as described above, to dewatering or separation. Here, the process produces dissolved solids in liquid (i.e., a clarified centrate) and suspended solids. The process sends a portion of the clarified centrate as clarified backset and another portion of the clarified centrate to the evaporators and dryer to produce DDGS.

Furthermore, the process sends the suspended solids to the treatment process. In some instances, the suspended solids may include but are not limited to solids, yeast, fat, and the like, based on using backset in the slurry tank. The treatment process includes, but is not limited to, applying a shearing device, using retention time, and/or supplying heat. In an embodiment, the shearing device shears the large-size particles to break them down in order to remove oil from other components. The advantages for shearing are to reduce the particle size and to break the bond between the oil and protein, fiber, germ, and the like. In another embodiment, the process uses retention time to allow the suspended solids mixed with the chemical to age for a period of time, ranging anywhere from about 0.5 hour up to about 12 hours in a settling tank. In another embodiment, the process may supply heat to the suspended solids for a predetermined amount of time in a settling tank. This may raise the temperature of the suspended solids to about 110 degrees F. (about 43° C. or about 316 K) and up to about 150 degrees F. (about 66° C. or about 339 K).

Advantages and benefits of the chemical process include: not creating a very fine grind that causes dough balls, not creating inert solids that will increase energy costs to move and to remove these inert solids, reducing energy costs associated with downstream processing, and paying reasonable capital costs associated with equipment. Thus, there are many advantages and benefits to using the chemical process in the production facility.

While aspects of described techniques can be implemented in any number of different environments, and/or configurations, implementations are described in the context of the following example processes.

### Illustrative Environments

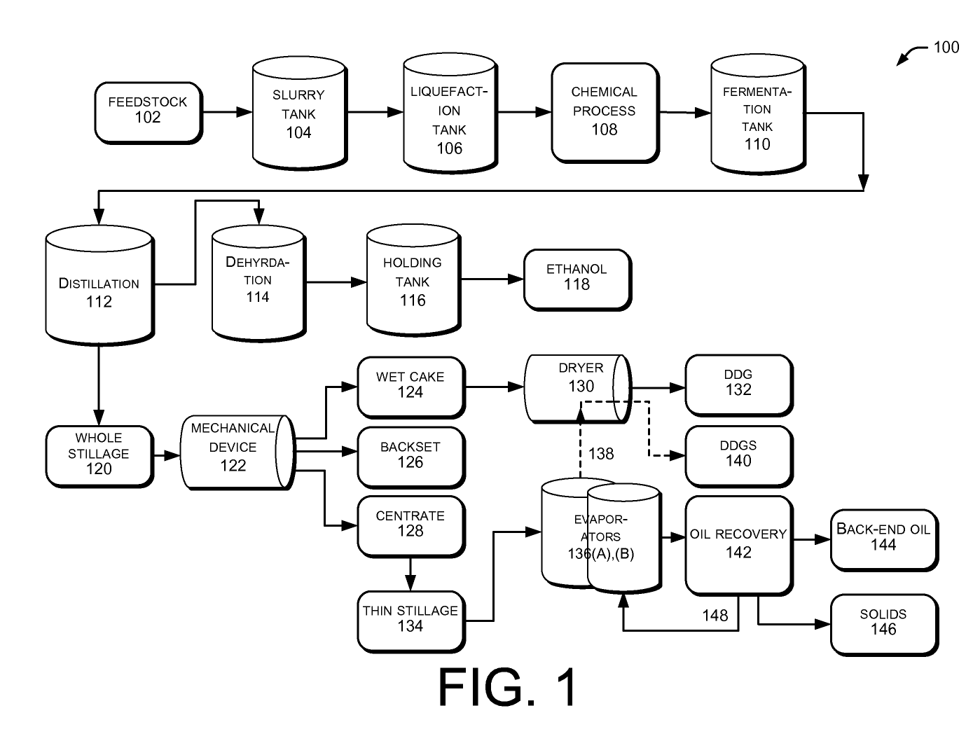

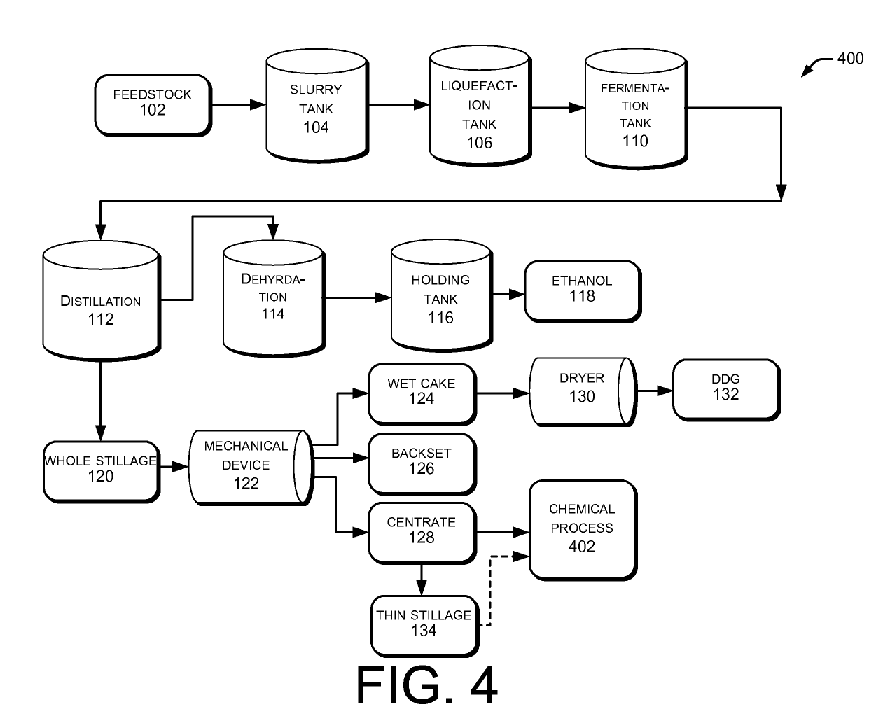

FIGS. 1 and 4 are flow diagrams showing example environments that may be used with the chemical process. The processes may be performed using a combination of different environments and/or types of equipment. Any number of the described environments, processes or types of equipment may be combined in any order to implement the method, or an alternate method. Moreover, it is also possible for one or more of the provided steps or pieces of equipment to be omitted.

FIG. 1 illustrates an example of a process 100 implementing a series of operations in a wet mill and/or a dry grind mill of an alcohol production facility. The process 100 in the production facility may operate in a continuous manner. In other implementations, the process 100 may operate in a batch process or a combination of batch and continuous processes.

The process 100 may receive feedstock of a grain that includes, but is not limited to, barley, beets, cassaya, corn, corn stover, cellulosic feedstock, grain, milo, oats, potatoes, rice, rye, sorghum grain, triticale, sweet potatoes, switchgrass, sugar cane, wheat, and the like, or pulp. Also, the feedstock may further include, grain fractions or by-products as produced by industry, such as hominy, wheat middlings, corn gluten feed, DDGS, and the like. The feedstock may include, an individual type, a combined feedstock of two types, of multiple types, or any combination or blend of the above grains. The feedstock may include, but is not limited to, one to four different types combined in various percentage ranges. The feedstock may be converted into different products and co-products that may include, but is not limited to, germ to be extracted for oil, food grade protein meal for high protein animal feed, and starch-based and fermentation-based products such as ethanol, syrup, food, and industrial starch. The feedstock may be processed for other applications that include, but are not limited to, producing chemicals for use in other applications, plastics, and the like.

For brevity purposes, the process 100 of using a single stream of feedstock will be described with reference to FIG. 1. As an example, corn may be used as a single feedstock. Corn may be broken down into its major components of endosperm, germ, bran, and tip cap. Each of these major components may be further broken down to their smaller components. The endosperm, the germ, the bran, and the tip cap each contains varying amounts of starch, protein, oil, fiber, ash, sugars, etc. For instance, the amounts of the components in corn may include, but are not limited to, about 70 to 74% starch, about 7 to 9% protein, about 3 to 4% oil, about 7 to 9% fiber, about 1 to 2% ash, about 1 to 2% sugars, and others.

One skilled in the art understands that inspecting and cleaning of the corn occurs initially. At 102, the process 100 initially grinds the feedstock 102 into a meal, a powder, or a flour to achieve an appropriate particle size. The process 100 may grind the feedstock 102 by using hammer mills or roller mills. This grinding serves to break an outer coating of the corn kernel and increases a surface area to expose starch for penetration of water in cooking.

In an embodiment, the process 100 uses a hammer mill (not shown). The hammer mill is a cylindrical grinding chamber with a rotating drum, flat metal bars, and a screen. The screen size may be, but is not limited to, 4/64 to 12/64 inch hole sizes. An example hammer mill may have screen openings that are sized 7/64 inch, or about 2.78 millimeters (mm) to create fine particles that are sized about 0.5 to about 2-3 mm.

In another embodiment, the process 100 uses a roller mill (not shown). The roller mill receives the feedstock 102, passes the feedstock 102 between two or more rolls or wheels, and crushes the feedstock 102 in the process 100. One roll may be fixed in position while the other roll may be moved further or closer towards the stationary roll. The roll surfaces may be grooved to help in shearing and disintegration of the corn. The example rolls may be about 9 to about 12 inches (23 to 30.5 cm) in diameter, with a ratio of length to diameter that may be about 4:1. The fine particles may be sized about 0.5 to about 2-3 mm.

At slurry tank 104, the process 100 adds water, backset, and enzymes to the feedstock 102 that has been ground to create a slurry. In an example, the process 100 adds a liquefying enzyme, such as alpha-amylase. The alpha-amylase enzyme hydrolyzes and breaks starch polymer into short sections, dextrins, which are a mix of oligosaccharides. The process 100 maintains a temperature between about 60 to about 100° C. (about 140 to about 212° F., about 333 to about 373 K) in the slurry tank 104 to cause the starch to gelatinize and a residence time of about 30 to about 60 minutes to convert insoluble starch in the slurry to soluble starch. The slurry may have suspended solids content of about 26 to about 40%, which includes starch, fiber, protein, and oil. Other components in the slurry tank 104 may include, grit, salts, and the like, as is commonly present on raw incoming grain from agricultural production, as well as recycle waters that contain acids, bases, salts, yeast, and enzymes. The process 100 adjusts the pH of the slurry to about 4.5 to 6.0 (depending on enzyme type) in the slurry tank 104.

In an embodiment, the slurry may be heated to further reduce viscosity of the ground grain. In some embodiments, there may be two or more slurry tanks used for an additional residence time and a viscosity reduction.

In an embodiment, the process 100 pumps the slurry to jet cookers (not shown) to cook the slurry. Jet cooking may occur at elevated temperatures and pressures. For example, jet cooking may be performed at a temperature of about 104 to about 150° C. (about 220 to about 302° F.) and at an absolute pressure of about 1.0 to about 6.0 kg/cm² (about 15 to 85 lbs/in²) for about five minutes. Jet cooking is another method to gelatinize the starch.

At liquefaction tank 106, the process 100 converts the slurry to mash. The process 100 uses a temperature range of about 80 to about 150° C. (about 176 to about 302° F., about 353 to about 423 K) to hydrolyze the gelatinized starch into maltodextrins and oligosaccharides to produce a liquefied mash. Here, the process 100 produces a mash stream, which has about 26 to about 40% total solids content. The mash may have suspended solids content that includes protein, oil, fiber, grit, and the like. In embodiments, one or more liquefaction tanks may be used in the process 100.

The process 100 may add another enzyme, such as glucoamylase in the liquefaction tank 106 to break down the dextrins into simple sugars. Specifically, the glucoamylase enzyme breaks the short sections into individual glucose. The process 100 may add the glucoamylase enzyme at about 60° C. (about 140° F.) before fermentation starts, known as saccharification, or at the start of a fermentation process. In an embodiment, the process 100 further adjusts the pH to about 5.0 or lower in the liquefaction tank 106. In another embodiment, saccharification and fermentation may also occur simultaneously.

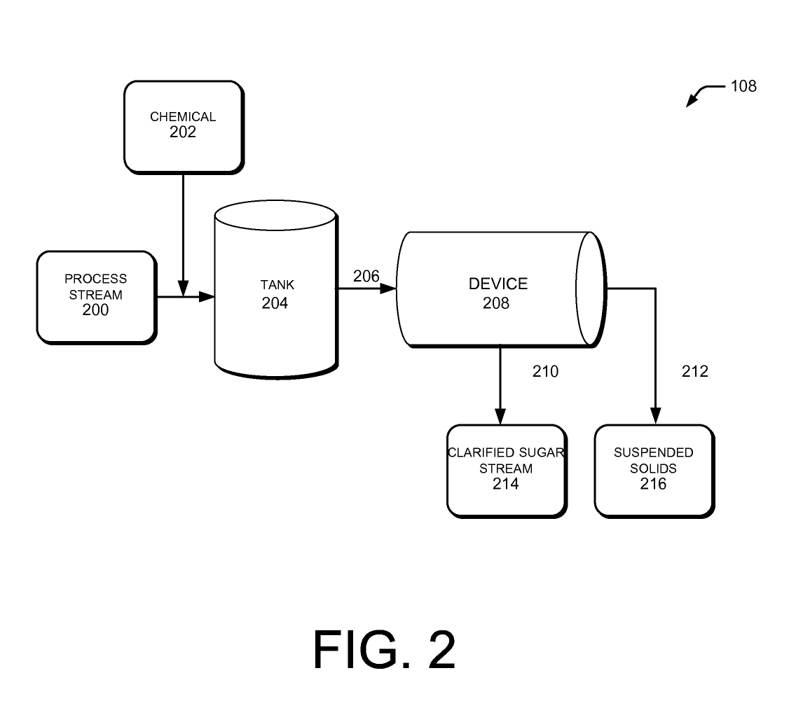

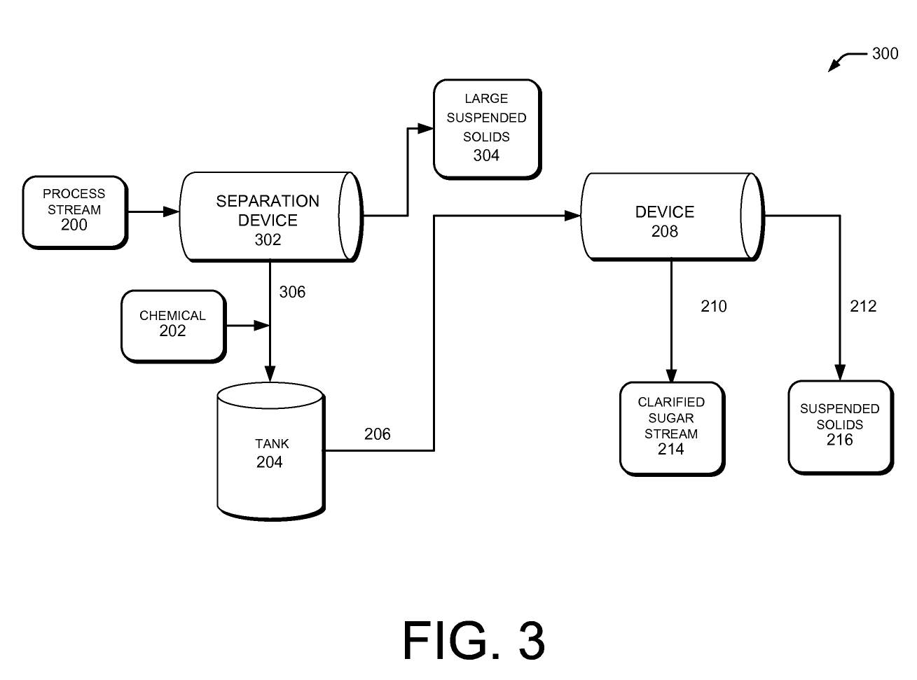

For illustrative purposes in FIG. 1, a chemical process 108 is presented at a high level. Details of embodiments of the chemical process 108 will be discussed later with reference to FIGS. 2-3. The chemical process 108 may be included with any process as part of the alcohol production facility or any type of process in a production facility. Specifically, the chemical process 108 helps to remove suspended solids, improve the separation of solids from liquids, increase the amount of product and co-products produced per bushel and to recover more oil per bushel of feedstock.

At liquefaction tank 106, the chemical process 108 obtains the process stream as slurry from the slurry tank 104. In other embodiments, the chemical process may obtain the process stream as slurry from a slurry tank, from a jet cooker, from a first liquefaction tank, from a second liquefaction tank, or after a pretreatment process in cellulosic production facility.

At fermentation tank 110, the process 100 sends a clarified sugar stream from the chemical process 108 to the fermentation tank. The process 100 adds a microorganism to the mash for fermentation in the fermentation tank 110. The process 100 may use a common strain of microorganism, such as Saccharomyces cerevisae to convert the simple sugars (i.e., maltose and glucose) into alcohol with solids and liquids, CO₂, and heat. The process 100 may use a residence time in the fermentation tank 110 as long as about 50 to about 60 hours. However, variables such as a microorganism strain being used, a rate of enzyme addition, a temperature for fermentation, a targeted alcohol concentration, and the like, may affect fermentation time. In embodiments, one or more fermentation tanks may be used in the process 100.

The process 100 creates alcohol, solids, and liquids through fermentation in the fermentation tank 110. Once completed, the mash is commonly referred to as beer, which may contain about 10 to about 20% alcohol, plus soluble and insoluble solids from the grain components, microorganism metabolites, and microorganism bodies. The microorganism may be recycled in a microorganism recycling step, which is an option.

Turning to 112, the process 100 distills the beer to separate the alcohol from the non-fermentable components, solids and the liquids by using a distillation process, which may include one or more distillation columns, beer columns, and the like. The process 100 pumps the beer through distillation 112, which is boiled to vaporize the alcohol or produce concentrated stillage. The process 100 condenses the alcohol vapor in distillation 112 where liquid alcohol exits through a top portion of the distillation 112 at about 88 to about 95% purity, which is about 190 proof. In embodiments, the distillation columns and/or beer columns may be in series or in parallel.

At 114, the process 100 removes any moisture from the 190 proof alcohol by going through dehydration. The dehydration 114 may include one or more drying column(s) packed with molecular sieve media to yield a product of nearly 100% alcohol, which is 200 proof alcohol.

At 116, the process 100 adds a denaturant to the alcohol prior to or in a holding tank. Thus, the alcohol is not meant for drinking but to be used for motor fuel purposes. At 118, an example product that may be produced is ethanol, to be used as fuel or fuel additive for motor fuel purposes.

At 120, the water-rich product remaining from the distillation 112 is commonly referred to as whole stillage. The components in the whole stillage 120 may include components such as, suspended solids, dissolved solids, and water. For instance, the components include oil, protein, fiber, minerals, acids, bases, recycled yeast, and the like. Whole stillage 120 falls to the bottom of the distillation 112 and passes through a mechanical device 122.

The mechanical device 122 separates the whole stillage 120 to produce wet cake 124 (i.e., insoluble solids) backset 126 (i.e., recycled to be used in front of process), and centrate 128 (i.e., liquids). The mechanical device 122 may include, but is not limited to, a centrifuge, a decanter, or any other type of separation device. The mechanical device 122 may increase solids content from about 10 to about 15% to about 25 to about 40% solids. There may be one or more mechanical devices.

The wet cake 124 are primarily solids, which may be referred to as Wet Distillers Grain (WDG). This includes, but is not limited to, protein, fiber, fat, and liquids. WDG may be stored less than a week to be used as feed for cattle, pigs, or chicken. Some of the wet cake 124 is transferred to one or more dryer(s) 130 to remove liquids. This drying produces Dried Distillers Grain (DDG) 132, which has a solids content of about 88 to 90% and may be stored indefinitely to be used as feed.

Returning to 128, the process 100 produces the centrate. The composition of the centrate 128 is mostly liquids left over from whole stillage 120 after being processed in the mechanical device 122. The process 100 sends the centrate 128, also referred to as thin stillage 134, to evaporators 136(A),(B) to boil away liquids from the thin stillage 134. This creates a thick syrup (i.e., about 25 to about 50% dry solids) which contains soluble or dissolved solids, fine suspended solids (generally less than 50 μm) and buoyant suspended solids from fermentation.

The evaporators 136(A),(B) may represent multiple effect evaporators, such as any number of evaporators, from one to about eight evaporators. Some process streams may go through a first effect evaporator(s) 136(A), which operate at higher temperatures, such as ranging to about 210° F. (about 99° C. or about 372 K). While other process streams may go through a second effect evaporator(s) 136(B), operated at slightly lower temperatures than the first effect evaporator(s) 136(A), such as ranging from about 130 to about 188° F. (about 54 to about 87° C. or about 328 to about 360 K). The second effect evaporator(s) 136(B) may use heated vapor from the first effect evaporator(s) 136(A) as heat or use recycled steam. In other embodiments, there may be three or four effect evaporator(s) which operate at lower temperatures than the second effect evaporator(s). In embodiments, the multiple effect evaporators may range from one effect up to ten effects. This depends on the plants, the streams being heated, the materials, and the like. In embodiments, the evaporators may be in series or in parallel.

The process 100 sends syrup from the evaporators 136(A) to the dryer 130 to produce DDGS 140. In some instances, the syrup may be combined with wet cake 124 processed by the mechanical device 122 and sold as DDGS.

In another embodiment, the process 100 may send the thin stillage 134 to a device for oil recovery 142, which removes oil from the thin stillage 134 to recover oil. As a result, the process 100 produces a product of back-end oil 144 and solids 146. The process 100 may send solids, water, and the like 148 from the oil recovery 142 back to the evaporators 136(B) for further processing.

### Illustrative Chemical Processes

FIGS. 2 and 3 illustrate examples of the chemical process that may be used with the environment of FIG. 1. FIG. 2 illustrates the chemical process 108 obtaining a process stream 200 as slurry from a liquefaction tank 106. As discussed, other embodiments include, but are not limited to, the chemical process 108 obtaining the process stream from a slurry tank, from a jet cooker, from a first or a second liquefaction tank, after a pretreatment tank in cellulosic process, any type of process streams in any type of production facilities, and the like.

The chemical 202 may include, but is not limited to, polymers, such as synthetic water-soluble polymers, dry polymers, emulsion polymers, inverse emulsion polymers, latex polymers, and dispersion polymers. The polymers may carry a positive (i.e., cationic), a negative charge (i.e., anionic), or no charge (i.e., nonionic). Polymers with charges may include, but are not limited to, cationic flocculants, cationic coagulants, anionic coagulants, and anionic flocculants. The cationic (i.e., positive charge) and anionic (i.e., negative charge) polymers may have an ionic charge of about 10 to about 100 mole percent, more preferably about 40 to 80 mole percent. There are mineral flocculants that are colloidal substances, such as activated silica, colloidal clays, and metallic hydroxides with polymeric structure (i.e., alum, ferric hydroxide, and the like).

The chemical 202 may include, but is not limited to, a single polymer, a flocculant used with a coagulant, a coagulant used with a flocculant, two or more flocculants, two or more coagulants, or a combination of different polymers to be added to the process stream. Furthermore, the chemical 202 may be used in varying concentrations, added at different stages, and the like.

Flocculants may include starch derivatives, mostly water-soluble, polysaccharides, and alginates. In embodiments, the polymer may be based on a polyacrylamide and its derivatives or an acrylamide and its derivatives. An example may include an acrylamide-acrylic acid resin C₆H₉NO₃ (i.e., hydrolyzed polyacrylamide, prop-2-enamide; prop-2-enoic acid). The polymers have a specific average molecular weight (i.e., chain length) and a given molecular distribution. For suspension, a certain degree of cationic or anionic is beneficial, as flocculating power may increase with the molecular weight. For instance, polyacrylamides have the highest molecular weight among synthetic chemicals, ranging in about 10 to about 20 millions. There are other polymers with specific properties that may be used under specific conditions include, but are not limited to, polyethylene-imines, polyamides-amines, polyamines, polyethylene-oxide, and sulfonated compounds.

The chemical 202 may be supplied as dry powder, liquid form, or concentrated solutions by suppliers who are skilled in the art. The preparation of the chemical 202 may require aging times and mixing, which are dependent on the type of products, chemicals, temperature of water, use of chemical within a certain period, and the like.

The chemical used is GRAS approved, meaning it satisfies the requirements for the United States' FDA category of compounds that are “Generally Recognized As Safe.” Since the chemical is GRAS approved or certified, it does not need to be removed and may be included in the distiller grains and be fed to livestock and/or other animals when used within the dosage and application guidelines established for the particular product formulation. Also, the chemical may be considered a processing aid under the government agencies, such as the U.S. Food and Drug Administration, the Center for Veterinary Medicine, and the Association of American Feed Control Officials based on their standards.

There are factors that affect flocculation and the amount of chemical to add to the process stream. These factors include, but are not limited to, amount of dosage, effect of shear on the flocs, particle size, density of materials, molecular weight, pH of materials, and temperature. The terms particles and solids are used interchangably to describe a state of matter, such as a composition of matter, not liquid, gas or plasma.

The chemical process 108 adds an effective amount of the chemical 202 to the process stream 200 in an inline static mixer (not shown) or in the tank 204. Other possible ways of adding the chemical include, but are not limited to fed into a clarifier, a thickener feedwell, and the like. A dosage amount of chemical 202 may range from about 10 to about 10,000 parts per million (ppm). Another dosage may be used in concentrations of about 0.05% to about 10% chemical 202 according to standard practices and recommended aging times for preparing dry polymers. The chemical 202 may be added at varying concentrations, at different stages of the process, and the like. The dosage amount of chemical 202 depends on factors, such as types of polymers provided, process streams, amount of flocculation desired, type of device used, and the like.

The chemical 202 induces flocculation by causing suspended particles or solids in the process stream 200 to form random, three-dimensional structures that are loose and porous, referred to as flocs. The chemical 202 causes the suspended particles or solids to come together or to collide, allowing large-size clusters to form. This improves the dewatering process by bringing the suspended particles or solids together and creating large-size clusters.

The chemical process 108 uses an agitator in the tank 204 to create sufficient agitation for complete and even distribution of the chemical 202. In an embodiment, the agitator may include a paddle prop that is flat to obtain desired mixing. However, excessive agitation is to be avoided, or excess shear may break down the flocs, since the bonding forces are relatively weak. Other types of mixing may include a low speed impeller on an agitator shaft, to gently mix the chemical in the process stream. The chemical process 108 agitates the chemical 202 with the process stream 200 in the tank 204 to create a mixture 206. The agitation time in the tank 204 may range from about 10 seconds to about 10 minutes. The time is dependent on the type of process stream, quantity of process stream, amount of chemical, speed of agitator, type of agitator, and the like.

Next, the process uses a device 208 to separate solids from liquids in the mixture 206, that is, removing or separating the suspended solids from dissolved solids in liquid stream. The mixture 206 may have about 15 to 18% solids. The device 208 may perform using mechanical energy, by a gravity separation, and the like. The device 208 may include, but is not limited to, rotary presses, rotary thickeners, rotary vacuum-drum filters, hydrocyclones, dynamic filtering screens, static screens, dewatering screens, pressure screens, gravity DSM screens, vibration screens, screw presses, belt filter presses, continuous belt filter presses, vacuum filters, centrifuges, paddle screens, dewatering screws, gravity separators, tanks, depth filters, columns, mixer-settlers, skimmers, and the like. The type of device 208 to be used depends on factors, such as the type of solids, type of process streams, type of chemical, liquid content at start and at end of process, and the like.

In an embodiment, the chemical process 108 uses a rotary drum thickener (RDT) that includes a screen of wedge-wire or woven mesh on a drum. The screen separates the liquids and dissolved particles or solids (i.e., starch, protein, gluten, salt, and the like) from the suspended solids (i.e., unhydrolyzed starch, gluten food grade protein, fiber, oil with germ particles). The screen has openings sized to allow water, starch, protein, and smaller sized particles or solids to flow through the screen but will not allow the larger sized particles or solids, such as fiber or oil with germ particles to flow through. Smaller screen openings increase the alcohol yield while providing an increase in concentration of protein and oil recovered through the screens.

The drum may be about 36 inches in diameter and about 72 inches long with 0.020 inch openings. The RDT includes internal and external spray system, flow distribution spray, variable drum drive system, drive belt, and the like. It may also include a chemical tank with mechanical mixer to mix the chemical 202 and inline magnetic flow meter to measure flow rate to dispense the chemical 202.

The RDT receives the mixture 206 of the process stream 200 and the chemical 202 from the tank 204. The RDT sends the mixture 206 onto a distribution tray where it is directed onto a portion of the rotating drum. A liquids and dissolved solids stream 210 passes through openings in the rotating drum while a suspended solids stream 212 remain on a drum surface for further dewatering. The RDT collects the liquids and dissolved solids stream 210 from the under side of the drum screen to a discharge chute into a tank or other suitable receiving device. The liquids and dissolved solids stream 210 may be referred to as a clarified sugar stream 214, which contains fermentable carbon source, oligosaccharides, to be sent to the fermentation tank 110 for fermenting to produce ethanol 118.

The RDT may include flights located inside of the rotating drum to slowly transport the suspended solids stream 212 towards a discharge end of the rotating drum. The suspended solids stream 212 may fall into a discharge chute into a tank or other suitable receiving device. The product may be referred to as suspended solids 216 to be further processed. Factors such as drum speed, mixer speed, and spray water cycling may be adjusted for maximum performance in the RDT. Any type or size of RDT may be implemented in this process, the one described above is an example of one.

In another embodiment, the chemical process 108 uses a rotary press to separate components in the mixture 206, such as separating the suspended solids from the liquids and dissolved solids stream. The rotary press includes a dewatering unit with a 36-inch channel, screen, gear unit, feed inlet, motor, filtrate discharge, and solids discharge. The rotary press receives the mixture 206 between two parallel filtering elements in the channel. The rotary press rotates the mixture 206 between the two parallel filtering elements to pass filtrate, the liquids and dissolved solids stream 210, while the suspended solids stream 212 advances with the channel. The rotary press dewaters the mixture 206 as it travels around the channel. The rotary press generates back pressure to dewater the suspended solids stream 212 and extrude suspended solids 216. It may also include a chemical tank with mechanical mixer to mix the chemical 202 and inline magnetic flow meter to measure flow rate to dispense the chemical 202. Any type or size of rotary press may be implemented in this process, the one described above is an example of one. The results are further discussed under the Examples of Test Results Section.

In other embodiments, the device 208 may operate by using gravity separation, which is efficient at separating one component, the suspended solids from the other components by gravity. This is possible due to all of the components of the mixture (i.e., process stream) having different specific weights. The gravity separation methods use gravity as a dominant force to separate out the components. For instance, the gravity separation separates the components based on the characteristic of the process stream, such as suspension. Advantages of using gravity separation include low capital and operating costs.

FIG. 3 is similar to FIG. 2, except this figure illustrates an embodiment of the chemical process 300 used with a separation device 302. The processes in FIG. 3 that are similar to the processes in FIG. 2 will not be described again. The separation device 302 occurs prior to adding the chemical 202 to the process stream 200. The separation device 302 separates large suspended solids 304 from small suspended solids and dissolved solids in liquid stream 306.

The separation device 302 may include, but is not limited to, centrifuge, paddle screen, or any type of mechanical processor that separates out large size particles from small size particles, solids from liquids, and the like.

The chemical process 300 adds the chemical 202 to the small-suspended solids and dissolved solids in liquid stream 306 using an inline static mixer or in the tank 204. Again, the chemical process 300 creates the mixture 206 to be processed through the device 208 to produce a clarified sugar stream 214 and suspended solids 216.

The chemical processes 108 of FIGS. 2 and 300 of FIG. 3 may include use of a chemical aid to assist with the flocculation. This chemical aid may include, but is not limited to aluminum ammonium sulfate, potassium sulfate, and the like. The chemical aid will reduce the amount of chemical needed to create the flocs and clusters. The chemical aid may also add density to slow-settling flocs to avoid being broken up during agitation. The amount of chemical aid may range from 4000 to 5000 ppm for 100 ppm of chemical being used. However, factors that may affect the dosage are based on type of chemical aid, type of chemical, process stream, amount of solids, and the like.

The chemical processes 108 of FIGS. 2 and 300 of FIG. 3 may include adjusting the pH of the process stream before adding the chemical. The pH may be adjusted to about 2 to about 10. In an embodiment, the process adjusts the pH ranging from about 4 to about 8 while in another embodiment, the process adjusts the pH ranging from about 3 to about 9. This ensures that the chemical will induce flocculation in the process stream. The type of materials to be added is bases and acids to adjust the pH, commonly understood by a person having ordinary skill in the art. The pH adjustment reduces the amount of chemical used in the process, which provides an economical benefit to the plant.

### Another Illustrative Environment

FIGS. 1 and 4 are flow diagrams showing example environments that may be used with the chemical process. In FIG. 1, the chemical process 108 obtains the process stream from the front end of the process. FIG. 4 is similar to FIG. 1, except this process 400 shows the chemical process 402 obtains the process stream from the back end of the process.

FIG. 4 illustrates the chemical process 402 obtaining a process stream, centrate 128. In another embodiment, the chemical process 402 may obtain a process stream, thin stillage 134, shown in a dotted line for illustrative purposes. Other embodiments include, but are not limited to, the chemical process 402 obtaining the process stream after distillation, as whole stillage, or any type of process streams in any type of production facilities, and the like.

### Other Illustrative Chemical Processes

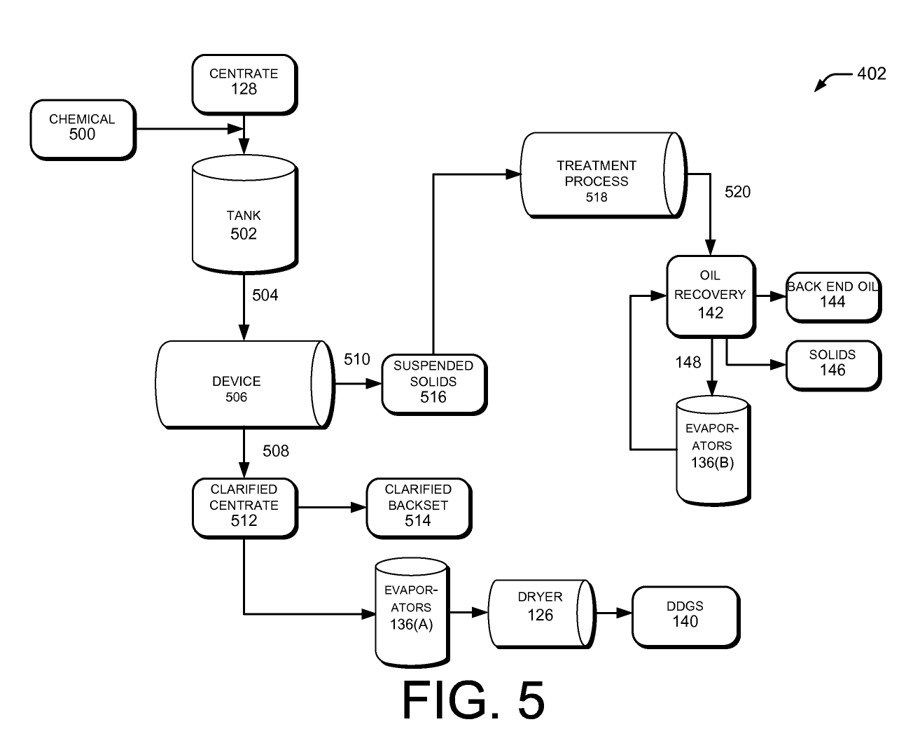

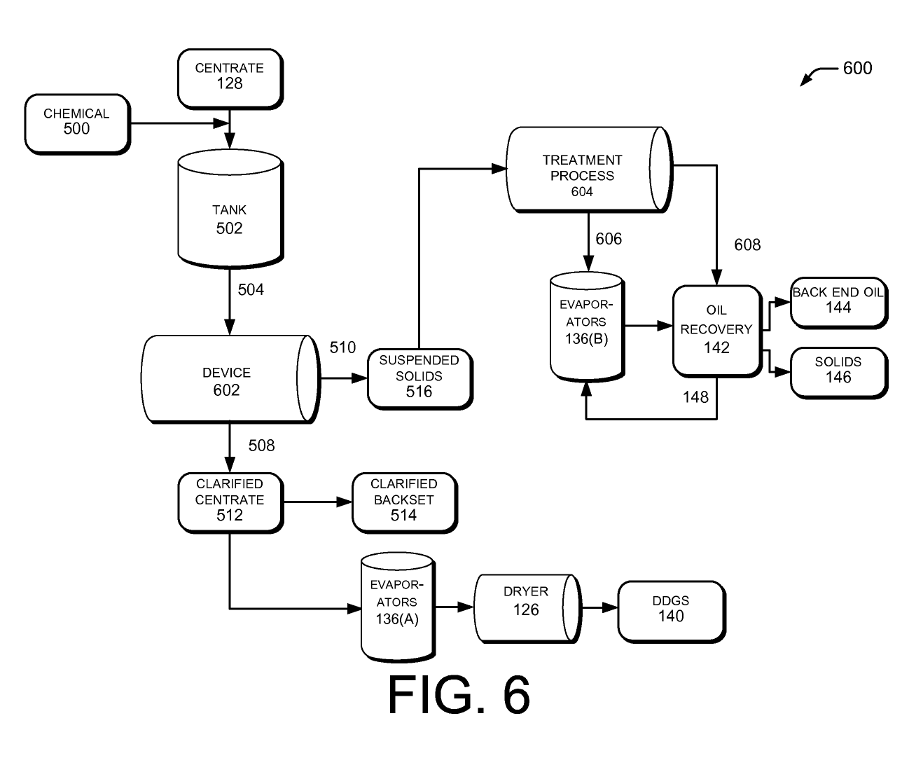

FIGS. 5 and 6 illustrate examples of the chemical process that may be used in the environment of FIG. 4. The chemical processes described with reference to FIGS. 5 and 6, use similar type of chemical, inline mixer, tank, and device as the chemical processes described with reference to FIGS. 2 and 3. However, the chemical process obtains the process stream from the back end and adds a treatment process. Thus, there are different processing downstream than previously discussed.

FIG. 5 illustrates the chemical process 402, uses the treatment process along with different processing downstream than what was discussed previously. The chemical process 402 adds an effective amount of the chemical 500 to the centrate 128 in an inline static mixer (not shown) or in the tank 502. A dosage amount of chemical 500 may range from about 10 to about 10,000 parts per million (ppm). Another dosage amount may be used in concentrations of about 0.05% to about 10% chemical 500 according to standard practices and recommended aging times for preparing dry polymers. The dosage amount of chemical 500 depends on factors, such as types of polymers provided, process streams, amount of flocculation desired, pH level, type of device used, and the like.

The chemical 500 induces flocculation by causing suspended particles in the centrate 128 to form random, three-dimensional structures that are loose and porous, referred to as flocs. The chemical 500 causes the suspended solids to come together or to collide, allowing large-size clusters to form. This improves the dewatering and separation processes by bringing the suspended solids together and creating large-size clusters.

The chemical process 402 uses an agitator in the tank 502 to create sufficient agitation for complete and even distribution of the chemical 500. In an embodiment, the agitator may include a paddle prop that is flat to obtain desired mixing. Other types of mixing devices may be used. However, excessive agitation is to be avoided, as excess shear may break down the flocs, since the bonding forces are relatively weak. The chemical process 402 agitates the chemical 500 with the centrate 128 in the tank 502 to create a mixture 504. The agitation time in the tank 502 may range from about 10 seconds to about 10 minutes. The time is dependent on the type of process stream, quantity of process stream, amount of chemical, speed of agitator, type of agitator, and the like.

Next, the chemical process 402 uses a device 506 to separate solids from liquids in the mixture 504, that is removing the suspended solids from dissolved solids in liquid stream. The mixture 504 may have about 15% to about 60% solids. The device 506 may perform using mechanical energy, by a gravity separation, and the like. The device 506 may include, but is not limited to, rotary presses, rotary thickeners, rotary vacuum-drum filters, hydrocyclones, dynamic filtering screens, static screens, dewatering screens, pressure screens, gravity DSM screens, vibration screens, screw presses, belt filter presses, continuous belt filter presses, vacuum filters, centrifuges, paddle screens, dewatering screws, gravity separators, tanks, depth filters, columns, mixer-settlers, skimmers, and the like. The type of device 506 to be used depends on factors, such as the type of solids, type of process streams, type of chemical, liquid content at start and at end of process, and the like.

In an embodiment, the device 506 may operate by using gravity separation, which is efficient at separating one component, the suspended solids from the other components by gravity. This is possible due to all of the components of the mixture (i.e., process stream) having different specific weights. The gravity separation methods use gravity as a dominant force to separate out the components. For instance, the gravity separation separates the components based on the characteristic of the process stream, such as suspension. Advantages of using gravity separation include low capital and operating costs.

In another embodiment, the chemical process 402 uses a rotary drum thickener (RDT) similar to the chemical process 108 described with reference to FIG. 2. The RDT includes a screen of wedge-wire or woven mesh on a drum. The screen separates the liquids and dissolved solids (i.e., starch, protein, gluten, salt, and the like) from the suspended solids (i.e., unhydrolyzed starch, gluten food grade protein, fiber, oil with germ particles). The screen has openings sized to allow water, starch, protein, and smaller sized particles to flow through the screen but will not allow the larger sized particles, such as fiber, oil with germ particles, and yeast to flow through. Smaller screen openings increase the alcohol yield while providing an increase in concentration of protein and oil recovered through the screens.

The drum may be about 36 inches in diameter and about 72 inches long with 0.020 inch openings. The RDT includes internal and external spray system, flow distribution spray, variable drum drive system, drive belt, and the like. It may also include a chemical tank with mechanical mixer to mix the chemical 500 and inline magnetic flow meter to measure flow rate to dispense the chemical 500.

The RDT receives the mixture 504 from the tank 502. The RDT sends the mixture 504 onto a distribution tray where it is directed onto a portion of the rotating drum. A liquids and dissolved solids stream 508 passes through openings in the rotating drum while a suspended solids stream 510 remain on a drum surface for further dewatering. The RDT collects the liquids and dissolved solids stream 508 from the under side of the drum screen to a discharge chute into a tank or other suitable receiving device. The liquids and dissolved solids stream 508 may be referred to as a clarified centrate 512, which contains few, if any suspended solids. The clarified centrate 512 may be recycled as clarified backset 514 to the front end of the process 400. This reduces the amount of energy needed to transport the clarified backset 514, lowers operating costs, helps with mass and energy balance, and increases efficiency in the production facility.

Furthermore, the clarified centrate 512 may be sent to first effect evaporators 136(A) to remove liquids. The clarified centrate 512 may contain about 4%-8% solids at start of entering first effect evaporators 136(A) and may have about 45 to 55% solids after exiting first effect evaporators 136(A).

The RDT may include flights located inside of the rotating drum to slowly transport the suspended solids stream 510 towards a discharge end of the rotating drum. The suspended solids stream 510 may fall into a discharge chute into a tank or other suitable receiving device, which is referred to as suspended solids 516 to be further processed. Factors such as drum speed, mixer speed, and spray water cycling may be adjusted for maximum performance in the RDT. Any type or size of RDT may be used, this is an example of one that may be used in this process.

Next, the chemical process 402 sends the suspended solids 516 to the treatment process 518. In some instances, the suspended solids 516 may include, but is not limited to about 15% solids, yeast, fat, and the like. The treatment process 518 includes, but is not limited to, applying a shearing device, using retention time, and/or supplying heat.

In an embodiment, the shearing device shears the large-size particles in the suspended solids 516 to break apart the flocs, which will help with removing oil from other components. The advantages for shearing are to reduce the particle size and to break the bond between the oil and protein, fiber, germ, and the like. The shearing device provides a small amount of shear to break the flocs and to break the bonds formed. The shearing device may include, but is not limited to, a centrifugal pump, a venturi pump, an aspirator pump, an agitator in a settling tank, a static mixer, a disc mill, and the like.

In another embodiment, the chemical process 402 uses retention time to allow the suspended solids 516 mixed with the chemical 500 to age for a period of time, ranging anywhere from about 0.5 hour up to about 12 hours in a settling tank. Factors that affect the retention time include, but are not limited to, type of chemical, type of process streams, solids content, and the like.

In yet another embodiment, the chemical process 402 may supply heat to the suspended solids 516 for a predetermined amount of time in a settling tank. The process 402 may raise the temperature in the settling tank. This may raise the temperature of the suspended solids to at about 110° F. (43° C. or 317 K) and up to about 150° F. (66° C. or 339 K). In another embodiment, the chemical process 402 adds a hydroheater to raise the temperature and to break the flocs of the suspended solids 516.

One of the goals is to make the oil inside the germ more accessible through shearing of the large-size particles. The treatment process 518 may use mechanical energy to separate the oil, to break up protein-starch interactions, and to condition the germ for better oil leach properties. Thus, more oil is available for recovery.

After the treatment process 518, the chemical process 402 sends the treated materials 520 to oil recovery 142 as shown in FIG. 5. The chemical process 402 sends the stream from oil recovery 142 to the second effect evaporators 136(B), which operate at a lower temperature than the first effect evaporators 136(A).

FIG. 6 is similar to FIG. 5, except this figure illustrates another embodiment of the chemical process 600 by using a different type of device and different processes downstream. In this embodiment, the chemical process 600 performs similar processes as in FIG. 5, up to the device 602.

In an embodiment, the device 602 may operate by using gravity separation, which is efficient at separating one component, the suspended solids from the other components by gravity. This is possible due to all of the components of the mixture (i.e., process stream) having different specific weights. The gravity separation methods use gravity as a dominant force to separate out the components. For instance, the gravity separation separates the components based on the characteristic of the process stream, such as suspension. Advantages of using gravity separation include low capital and operating costs.

In an embodiment, the device 602 is a rotary press. Starting at 602, the chemical process 600 uses the rotary press to separate components in the mixture 504, such as separating the suspended solids stream 510 from the liquids and dissolved solids stream 508. The rotary press includes a dewatering unit with a 36-inch channel, screen, gear unit, feed inlet, motor, filtrate discharge, and solids discharge. The rotary press receives the mixture 504 between two parallel filtering elements in the channel. The rotary press rotates the mixture 504 between the two parallel filtering elements to pass filtrate, the liquids and dissolved solids stream 508, while the suspended solids stream 510 advances with the channel. The rotary press dewaters the mixture 504 as it travels around the channel. The rotary press generates back pressure to dewater the suspended solids stream 510 and extrude suspended solids 516. It may also include a chemical tank with mechanical mixer to mix the chemical 500 and inline magnetic flow meter to measure flow rate to dispense the chemical 500. Any type or size of rotary press may be used, this is an example of one that may be used in this process.

Next, the chemical process 402 sends the suspended solids 516 to a treatment process 604. In some instances, the suspended solids 516 may include, but is not limited to about 15% solids, fat, yeast, and the like. The treatment process 602 includes, but is not limited to, adding water, using retention time, and/or supplying heat.

In an embodiment, the chemical process 600 adds water to dilute the suspended solids 516. This further assists in breaking up the flocs. The amount of water varies depending on the type of watering device, type of chemical, and the like.

In another embodiment, the chemical process 600 uses retention time to allow the suspended solids 516 mixed with the chemical 500 to age for a period of time, ranging anywhere from about 0.5 hour up to about 12 hours in a settling tank. Factors that affect the retention time, include but are not limited to, type of chemical, type of process streams, solids content, and the like.

In yet another embodiment, the chemical process 600 may supply heat to the suspended solids 516 for a predetermined amount of time in a settling tank. The process 600 may raise the temperature in the settling tank. This may raise the temperature of the suspended solids to at about 110° F. (43° C. or 316 K) and up to about 150° F. (66° C. or 339 K). In another embodiment, the chemical process 600 implements a hydroheater to raise the temperature of the suspended solids 516.

One of the goals is to make the oil inside the germ more accessible through shearing of the large-size particles. The chemical process 600 helps separate the oil, to break up protein-starch interactions, and to condition the germ for better oil leach properties. Thus, more oil is available for recovery.

After the treatment process 604, the chemical process 600 sends a stream with mostly liquid 606 to second effect evaporators 136(B) and sends a stream with mostly solids 608 for oil recovery 142.

The chemical processes 402 and 600 may include, use of a chemical aid to assist with the flocculation. This chemical aid may include, but is not limited to aluminum ammonium sulfate, potassium sulfate, and the like. The chemical aid will reduce the amount of chemical needed to create the flocs and clusters. The amount of chemical aid may range from 4000 to 5000 ppm for 100 ppm of chemical being used. However, factors affect the dosage based on type of chemical aid, type of chemical, process stream, amount of solids, and the like.

The chemical processes 402 and 600 may also include adjusting the pH of the process streams before adding the chemical. For instance, the process adjusts the pH by adding sodium to increase the pH. Examples include caustic (NaOH), alkaline, alkali, base. An embodiment includes the process adding 50% caustic to the process stream before adding the chemical.

### Examples of Test Results

The chemical process was replicated in a pilot plant based on using thin stillage as the process stream, adjusting the pH on the thin stillage, adding a chemical, and using a rotary press. Table I. below indicates the different variables in the pilot plant runs.

TABLE I
Chemical Process Back-End

| | Polymer | | | |
|---|---|---|---|---|
| Runs | Dosage | Filtrate | Solids | Capture Rate |
| 1a | 25% | 0.21% | 31.16% | 97.3% |
| 1b | 30% | 0.04% | 35.40% | 99.4% |
| 1c | 22% | 0.64% | 33.86% | 90.9% |
| 1d | 35% | 0.46% | 33.24% | 93.7% |
| 1e | 35% | 0.69% | 28.63% | 90.9% |

Table I shows in a first vertical column the different runs, 1a-1e, and shows in a first row, Polymer Dosage, Filtrate, Solids, and Capture Rate. The data illustrates excellent capture rates ranging from 90.9 to 99.4% based on the filtrate percent. Using a higher polymer dosage percentage in 1e, showed a higher filtrate percentage, but not a higher capture rate percentage.

The pH was adjusted from about 2 to about 10 to determine the amount of chemical, polymer to be added. The chemical used is a cationic flocculant.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A method comprising:
adding an effective amount of a cationic flocculant to a process stream;
agitating the cationic flocculant in the process stream in a tank for a predetermined amount of time to induce flocculation of two or more particles to aggregate and to form flocs of suspended particles;
removing the flocs of suspended particles from dissolved particles in the process stream with the cationic flocculant; and
producing a suspended particles stream and a clarified process stream.

2. The method of claim 1, wherein the predetermined amount of time compromises ranging from about 10 seconds to about 10 minutes.

3. The method of claim 1, wherein the removal of the flocs of suspended particles compromises using at least one of a rotary press, a rotary drum thickener, a dynamic filtering screen, a gravity separation, or a paddle screen.

4. The method of claim 1, further compromises prior to adding the effective amount of the cationic flocculant, processing the process stream to separate large suspended solids from small suspended solids having dissolved solids in a liquid stream.

5. The method of claim 1, further compromises prior to adding the effective amount of the cationic flocculant, adjusting pH of the process stream to range from about 2 to about 10.

6. The method of claim 1, wherein the cationic flocculant is Generally Regarded As Safe certified.

7. A method comprising:
adjusting pH of a process stream;
adding an effective amount of a charged polymer to the process stream to cause suspended solids to aggregate, forming flocs;
separating the flocs of the suspended solids from the process stream with the charged polymer; and
creating a suspended solids stream and a liquid with dissolved solids stream.

8. The method of claim 7, wherein adjusting the pH of the process stream compromises the pH ranging from about 4 to about 8.

9. The method of claim 7, wherein the process stream is obtained as slurry from a liquefaction tank.

10. The method of claim 7, wherein the process stream is obtained after being processed by a mechanical separation device to create thin stillage.

11. The method of claim 7, wherein the separating the flocs of the suspended solids from the process stream with the charged polymer compromises using at least one of a mechanical device or a gravity separation.

12. The method of claim 7, wherein the charged polymer compromises at least one of a polyacrylamide and its derivatives or an acrylamide and its derivatives.

13. The method of claim 7, wherein the charged polymer compromises at least one of a cationic flocculant or a cationic coagulant.

14. A method comprising:
adding an effective amount of a chemical for producing flocculation in a process stream;
agitating the chemical in the process stream in a tank to induce flocculation of suspended solids; and
separating the flocculation of suspended solids from the process stream with the chemical.

15. The method of claim 14, wherein the agitating the chemical compromises using a predetermined amount of time ranging from about 30 seconds to about 9 minutes.

16. The method of claim 14, further compromising, creating a suspended solids stream and a liquid with dissolved solids stream.

17. The method of claim 14, further compromising adding a chemical aid to assist with the flocculation of the suspended solids.

18. The method of claim 17, wherein the chemical aid compromises at least one of an aluminum ammonium sulfate or a potassium sulfate.

19. The method of claim 14, further compromises adjusting pH of a process stream prior to adding the chemical for producing flocculation.

20. The method of claim 19, wherein the pH is adjusted ranging from about 3 to about 9.
